(19) United States
(12) Patent Application Publication
(10) Pub. No.: US 2025/0310624 A1
(43) Pub. Date: Oct. 2, 2025

(54) INFORMATION PROCESSING APPARATUS, AND INFORMATION PROCESSING METHOD

(71) Applicant: CANON KABUSHIKI KAISHA, Tokyo (JP)

(72) Inventors: TAKASHI KOBAYASHI, Tokyo (JP); TAIKI MASHIMO, Tokyo (JP); KOKI SAKABA, Fukuoka (JP)

(21) Appl. No.: 19/087,656

(22) Filed: Mar. 24, 2025

(30) Foreign Application Priority Data
Mar. 29, 2024 (JP) 2024-055498

(51) Int. Cl. H04N 23/55; H04N 5/265; H04N 23/663

(52) U.S. Cl. CPC H04N 23/55; H04N 5/265; H04N 23/663

(57) ABSTRACT

An information processing apparatus according to the present invention including a processor, and a memory storing a program which, when executed by the processor, causes the information processing apparatus to execute acquisition processing of acquiring a diaphragm value of a lens of an imaging apparatus, and execute output processing of outputting the diaphragm value acquired during capturing of a captured image of the imaging apparatus and blur shape-related information related to a shape of blur occurring in the captured image.

### BACKGROUND OF THE INVENTION

### Field of the Invention

The present invention relates to an information processing apparatus, and particularly relates to technology for synthesizing a real object (object in real) with a graphic (computer graphics (CG) image).

### Description of the Related Art

In recent years, there is an increasing need for video contents using VisualEffects technology for synthesizing a real object with a graphic (CG image). Video contents shooting using VisualEffects technology is generally called VFX shooting. There are roughly two types of VFX shooting. A first method is a post-production method in which shooting is performed with a special background such as a green screen and then a graphic is synthesized to the background of the shot image in post-production. A second method is an in-camera method in which shooting is performed with graphics displayed on a large display device as a background. In VFX shooting, by using the CG, a realistic image can be obtained without going to an actual place, or an image having an angle of view or a composition that is difficult in real can be obtained, so that production costs can be reduced to low cost. Therefore, demand for VFX shooting is increasing. In VFX shooting, it is desired to obtain a natural synthetic image (synthetic image without discomfort).

JP 2004-227332 A discloses technology for changing a synthetic position of a graphic according to an orientation of a camera. JP 2021-532649 A discloses a technology of generating a point image distribution function based on a distance from an incident pupil of a lens and a size of an exit pupil and generating a graphic based on the point image distribution function.

Meanwhile, in related arts, a camera including an imaging element of ⅔ inches or 1 inch size has been generally used, but in recent years, cameras including a large imaging element such as SUPER 35 mm or a full frame of 35 mm have increased. With an increase in size of the imaging element, a settable depth of field becomes wider, and a degree of freedom of blur expression increases. Important factors of blur include intensity (degree of spread) and a shape that can be expressed by a point image intensity distribution function. In VFX shooting of the related arts, a graphic considering a blur shape occurring in a shot image cannot be generated, and a natural synthetic image cannot be obtained.

### SUMMARY OF THE INVENTION

The present invention provides technology that makes it possible to obtain a more natural image (image with less discomfort) as a synthetic image obtained by synthesizing a real object with a graphic.

The present invention in its first aspect provides an information processing apparatus including a processor, and a memory storing a program which, when executed by the processor, causes the information processing apparatus to execute acquisition processing of acquiring a diaphragm value of a lens of an imaging apparatus, and execute output processing of outputting the diaphragm value acquired during capturing of a captured image of the imaging apparatus and blur shape-related information related to a shape of blur occurring in the captured image.

The present invention in its second aspect provides an information processing method including acquiring a diaphragm value of a lens of an imaging apparatus, and outputting the diaphragm value acquired during capturing of a captured image of the imaging apparatus and blur shape-related information related to a shape of blur occurring in the captured image.

The present invention in its third aspect provides a non-transitory computer readable medium that stores a program, wherein the program causes a computer to execute an information processing method including acquiring a diaphragm value of a lens of an imaging apparatus, and outputting the diaphragm value acquired during capturing of a captured image of the imaging apparatus and blur shape-related information related to a shape of blur occurring in the captured image.

Further features of the present invention will become apparent from the following description of embodiments with reference to the attached drawings.

### BRIEF DESCRIPTION OF THE DRAWINGS

FIG. 1 is a block diagram of a camera according to a first embodiment;

FIG. 2 is a schematic diagram of a shooting site;

FIG. 3 is a schematic diagram of a synthetic image;

FIG. 4 is a schematic diagram of a shooting site;

FIG. 5 is a schematic diagram of a synthetic image;

FIG. 6 is a schematic diagram of a diaphragm;

FIG. 7 is a schematic diagram of a blur shape;

FIG. 8 is a schematic diagram of correspondence relationship information;

FIG. 9 is a schematic diagram of a blur shape;

FIG. 10 is a schematic diagram of correspondence relationship information;

FIG. 11 is a schematic diagram of communication between a camera main body and a lens unit;

FIG. 12 is a schematic diagram of communication between the camera main body and the lens unit;

FIG. 13 is a schematic diagram of communication between the camera main body and the lens unit;

FIG. 14 is a schematic diagram of communication between the camera main body and a CG generation device;

FIG. 15 is a schematic diagram of communication between the lens unit, the camera main body, and the CG generation device;

FIG. 16 is a block diagram of a camera according to a second embodiment; and

FIG. 17 is a block diagram of a lens unit according to a third embodiment.

### DESCRIPTION OF THE EMBODIMENTS

### First Embodiment

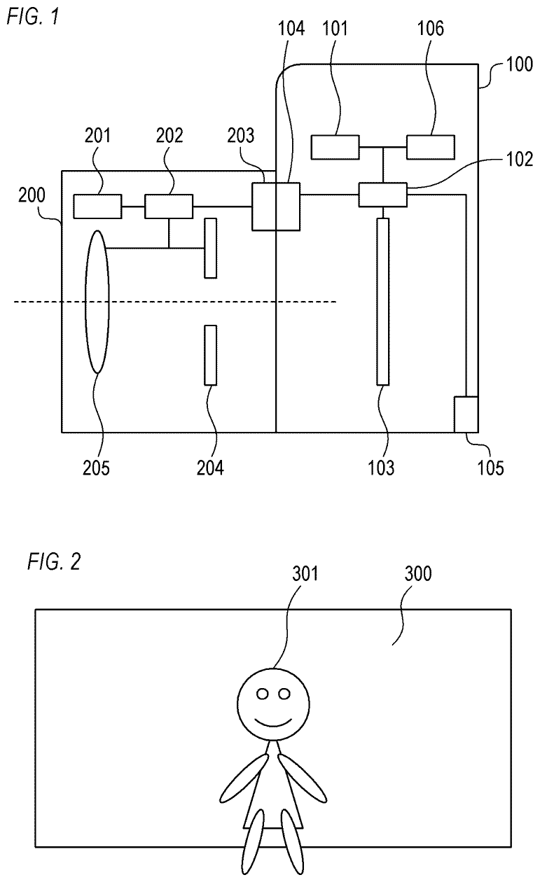

Hereinafter, a first embodiment of the present invention will be described. FIG. 1 is a block diagram illustrating a configuration of a camera main body 100 as an example of an information processing apparatus according to a first embodiment. The camera main body 100 is an imaging apparatus in which a lens unit (lens and lens device) is interchangeable. In FIG. 1, a lens unit 200 is attached to the camera main body 100.

The camera main body 100 includes a memory 101, a central processing unit (CPU) 102, an imaging element 103, a communication terminal 104, an output terminal 105, and a recording medium 106.

The memory 101 is a storage unit that stores various types of data (various types of information) including images. The data stored in the memory 101 can be read from the memory 101 when necessary. The memory 101 includes a volatile region capable of storing data only during energization and a nonvolatile region capable of storing data even while energization is stopped.

The CPU 102 is a control unit that controls each unit of the camera main body 100 and each unit of an accessory (the lens unit 200 in FIG. 1) attached to the camera main body 100. For example, programs, various parameters, and the like for operating the CPU 102 are stored in the memory 101, and the CPU 102 performs various controls by reading the programs from the nonvolatile region of the memory 101, loading the programs in the volatile region, and executing the programs.

The imaging element 103 is, for example, a charge storage type solid-state imaging element such as a CMOS or a CCD, and receives a light flux (light flux of an object) guided into the camera main body 100 via the lens unit 200 and converts the light flux into an electrical image signal. An image (signal) obtained by the imaging element 103 is used for live view display, recording on the recording medium 106 to be described below, external output using the output terminal 105, and the like under control of the CPU 102. The CPU 102 can also control an exposure time of the imaging element 103, a shooting timing (a timing for performing shooting (capturing)), and the like.

The communication terminal 104 is a terminal for communicating with a lens unit (lens unit 200 in FIG. 1) attached to the camera main body 100.

The output terminal 105 is, for example, an Ethernet terminal, an SDI terminal, an HDMI (registered trademark) terminal, or the like, and is used for outputting various types of data (various types of information) including an image to the outside or acquiring various types of data (various types of information) from the outside.

The recording medium 106 is a recording medium detachable from the camera main body 100, and is, for example, an SD card, CFExpress, or the like. Various types of data (various types of information) including images can be recorded in the recording medium 106.

The lens unit 200 includes a memory 201, a lens processing unit (LPU) 202, a communication terminal 203, a diaphragm 204, and a lens group 205. The lens unit 200 is a so-called interchangeable lens detachable from an imaging apparatus.

The memory 201 is a storage unit that stores various types of data (various types of information). The data stored in the memory 201 can be read from the memory 201 when necessary. The memory 201 includes a volatile region capable of storing data only during energization and a nonvolatile region capable of storing data even while energization is stopped.

The LPU 202 is a control unit that controls each unit of the lens unit 200. For example, programs, various parameters, and the like for operating the LPU 202 are stored in the memory 201, and the LPU 202 performs various controls by reading the programs from the nonvolatile region of the memory 201, loading the programs in the volatile region, and executing the programs.

The communication terminal 203 is a terminal for communicating with an imaging apparatus (the camera main body 100 in FIG. 1) to which the lens unit 200 is attached. In FIG. 1, the LPU 202 of the lens unit 200 and the CPU 102 of the camera main body 100 are connected to each other via the communication terminal 203 of the lens unit 200 and the communication terminal 104 of the camera main body 100. The LPU 202 can drive (control) each unit of the lens unit 200 according to a control instruction from the CPU 102.

The diaphragm 204 is a light amount control member that controls (adjusts) an amount of light of the light flux guided into the camera main body 100. For example, by changing a diaphragm value, an aperture diameter of the diaphragm 204 is changed to an aperture diameter corresponding to the changed diaphragm value, and the light amount is changed. Not only the light amount but also a depth of field and blur can be changed.

The lens group 205 includes a focus lens, a zoom lens, a shift lens, and the like. The light flux of the object is guided into the camera main body 100 via the lens group 205 and the diaphragm 204. The position of each lens included in the lens group 205 can be controlled (changed). For example, the focus lens can be moved in an optical axis direction to adjust focus on the object.

The camera main body 100 (and the lens unit 200) is used for, for example, VFX shooting for synthesizing a real object with a graphic (CG image).

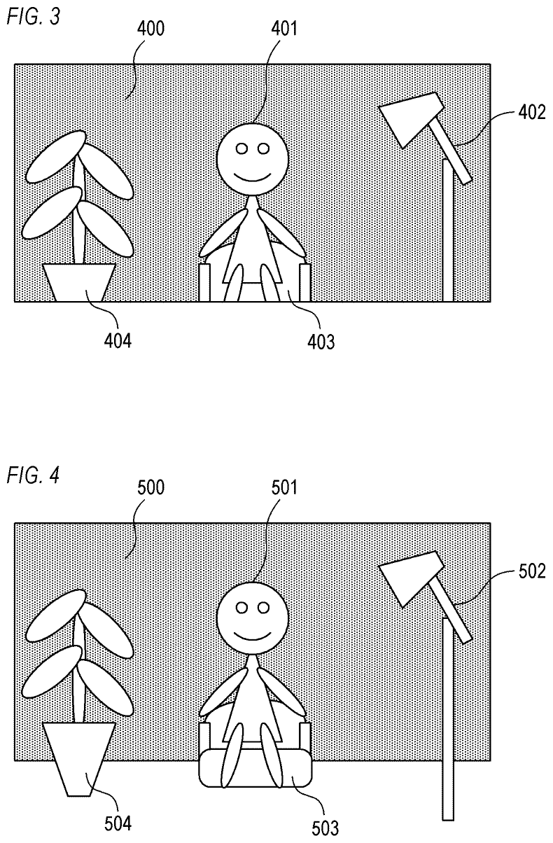

VFX shooting of the post-production method will be described with reference to FIGS. 2 and 3. FIG. 2 is a schematic diagram illustrating an example of a shooting site, and FIG. 3 is a schematic diagram illustrating an example of a synthetic image obtained by synthesizing a real object with a graphic.

In VFX shooting of the post-production method, first, shooting is performed with a special background. In the example of FIG. 2, a real object 301 is shot with a green screen 300 as a background. Note that the background is not limited to the green screen (green single-color background), and may be, for example, another single-color background or another patterned background.

Next, a CG synthesis device transfers a shot image to CG synthesis editing software, detects a background region from the shot image, and synthesizes a background graphic to the detected region. Graphics other than the background may also be synthesized. In the example of FIG. 3, a background graphic 400 and graphics 402 to 404 other than the background are synthesized. The graphics 402 to 404 other than the background are objects disposed before the graphic 400 of the background.

Information such as an in-focus position during shooting is recorded as metadata of the shot image, and blur of each of the graphics 400 and 402 to 404 is individually controlled (adjusted) based on the information. For example, a blurring manner of the background graphic 400 is different from a blurring manner of the graphics 402 to 404 other than the background. By generating and synthesizing the graphics 400 and 402 to 404 so that a blurring manner of the real object 401 (301) and the blurring manners of the graphics 400 and 402 to 404 match each other, a natural synthetic image (synthetic image without discomfort) can be generated.

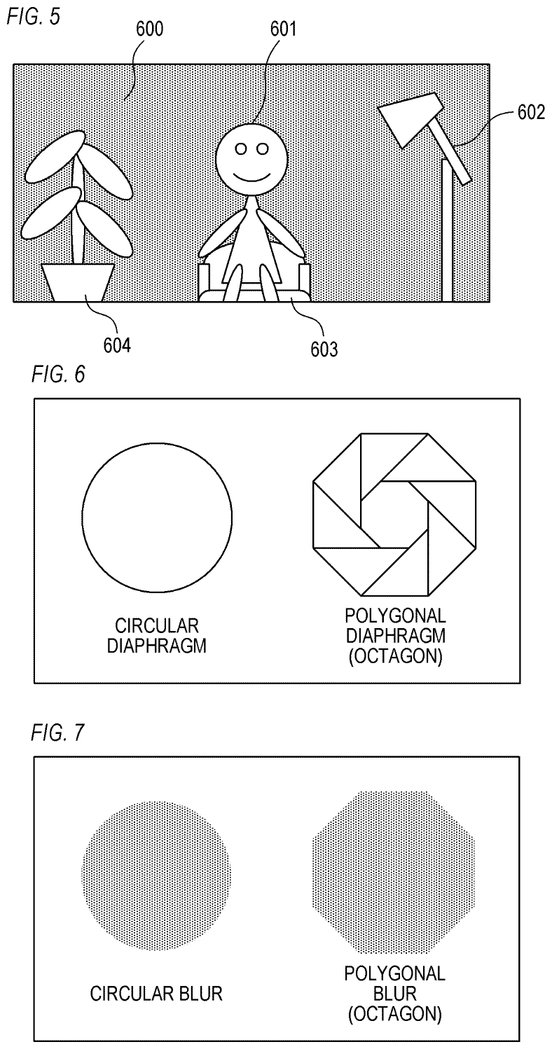

VFX shooting of the in-camera method will be described with reference to FIGS. 4 and 5. FIG. 4 is a schematic diagram illustrating an example of a shooting site, and FIG. 5 is a schematic diagram illustrating an example of a synthetic image obtained by synthesizing a real object with a graphic.

In the VFX shooting of the in-camera method, shooting is performed with a graphic displayed on a large display device as a background. In the example of FIG. 4, real objects 501 to 504 are shot with a graphic displayed on a display device 500 as a background. Here, information such as an in-focus position is output from a camera in real time (sequentially during shooting) and is input to a CG generation device. The CG generation device generates a graphic having blur based on the input information as a graphic to be displayed on the display device 500. By the camera performing shooting of an image at an angle of view including the graphic displayed on the display device 500 and the real objects 501 to 504, a synthetic image of FIG. 5 is obtained. Note that information such as an in-focus position may be transmitted from the camera main body to the CG generation device, or may be transmitted from the lens unit to the CG generation device without passing through the camera main body. Information such as an in-focus position may be transmitted from the lens unit to the CG generation device via a device that is not the camera main body (for example, a device that converts information acquired from the outside into information that can be input to the CG generation device).

Blur will be described. Blur includes an intensity (degree of spread) and a shape as important factors. In VFX shooting of the related arts, an intensity of blur of a graphic is controlled (adjusted) based on a diaphragm value, an in-focus position, and the like, but a graphic considering a shape of blur occurring in a shot image cannot be generated, and a natural synthetic image cannot be obtained.

In the shot image, blur occurs for an out-of-focus object. A blur intensity is determined according to a defocus degree such as a deviation amount from a depth of field based on a diaphragm value or a size of the imaging element or a deviation amount from an object distance corresponding to an in-focus position (focus position). Meanwhile, a blur shape is not determined according to the diaphragm value, the size of the imaging element, the in-focus position, and the like, but is determined according to a shape of aperture of the diaphragm.

FIG. 6 is a schematic diagram illustrating an example of a circular diaphragm having a circular aperture and a polygonal diaphragm (iris diaphragm) having a polygonal aperture. In FIG. 6, a diaphragm having an octagonal aperture is illustrated as the polygonal diaphragm. FIG. 7 is a schematic diagram illustrating an example of a shape of blur occurring in a shot image. Circular blur occurs for the circular diaphragm, and polygonal blur occurs for the polygonal diaphragm. When the number of diaphragm blades of the polygonal diaphragm is eight, octagonal blur occurs. When an edge of the diaphragm blade forming the aperture of the diaphragm has a curvature, blur having a shape of a polygon close to a circle may occur instead of a regular polygon. Even in the polygonal diaphragm, when the aperture of the diaphragm becomes circular by opening, circular blur occurs. As described above, the blur shape depends on the specification of the lens unit (diaphragm) and the diaphragm value. Here, for simple description, the blur shape when an ideal point light source is shot is described, but blur having a shape according to the above-described shape also occurs in a region of an object other than the point light source.

When information that can specify (determine) the blur shape is not notified to the CG generation device or the CG synthesis device, the blur shape of the generated graphic and the blur shape of the real object does not match, and an unnatural synthetic image (synthetic image with discomfort) is generated. Therefore, in the first embodiment, the camera main body 100 outputs blur shape-related information, that is information related to the blur shape, from the output terminal 105 to the outside or records the information on the recording medium 106 so that the CG generation device or the CG synthesis device can acquire the blur shape-related information. In the post-production method, the diaphragm value is acquired, and a shot image is output together with the diaphragm value during shooting of the shot image and the blur shape-related information related to the shape of blur occurring in the shot image. The processing may or may not be performed in real time. In the in-camera method, the diaphragm value is acquired in real time, and the diaphragm value and the blur shape-related information are output in real time. The output diaphragm value is used to determine the blur intensity of the graphic, and the output blur shape-related information is used to determine the blur shape of the graphic. When the blur shape-related information is not information indicating the blur shape, the diaphragm value may be used to identify the blur shape.

A method of generating the blur shape-related information will be described. In the first embodiment, it is assumed that the blur shape-related information indicates a blur shape. As described above, the blur shape depends on the specification of the lens unit (diaphragm) and the diaphragm value. Therefore, when the lens unit to be used is determined in advance, the blur shape-related information can be generated (acquired) based only on the diaphragm value. In the first embodiment, the memory 101 stores correspondence relationship information indicating a correspondence relationship between the diaphragm value and the blur shape-related information. Then, the CPU 102 acquires the blur shape-related information corresponding to the diaphragm value to be output based on the correspondence relationship information, and outputs the blur shape-related information.

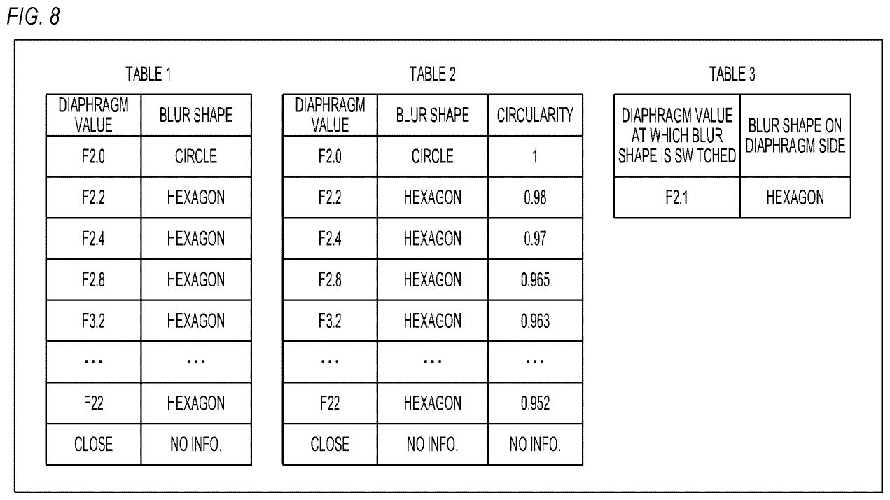

FIG. 8 is a schematic diagram illustrating an example of the correspondence relationship information. In FIG. 8, tables 1 to 3 are illustrated as the correspondence relationship information. In Table 1, the blur shape-related information indicates the blur shape, and a plurality of combinations of the diaphragm value and the blur shape are described. By using Table 1, the blur shape can be known from the diaphragm value. Note that the diaphragm value described in the table may be only a representative value, and the blur shape-related information corresponding to the diaphragm value not described in the table may be acquired by interpolation processing or the like using the information described in the table. In Table 2, the blur shape-related information indicates the blur shape and circularity (similarity of the blur shape compared to a perfect circle), and a plurality of combinations of the diaphragm value, the blur shape, and the circularity are described. By using Table 2, a more accurate blur shape can be known when the circularity changes depending on the diaphragm value. Table 3 illustrates a threshold value, that is a diaphragm value at which generated blur is switched between circular blur and polygonal blur, and a shape (polygonal shape) of blur that occurs when the diaphragm value is smaller than the threshold value (on the diaphragm side). By using Table 3, it can be determined that circular blur occurs when the diaphragm value is larger than the threshold value (on the opening side), and it can be determined that polygonal blur occurs when the diaphragm value is smaller than the threshold value (on the diaphragm side). Note that the threshold value may be a lower limit of a diaphragm value at which circular blur occurs or an upper limit of a diaphragm value at which polygonal blur occurs.

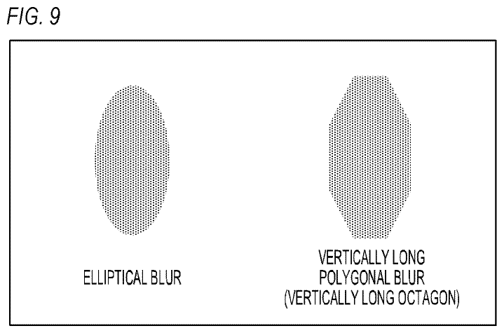

Examples of a special blur shape include a blur shape when an anamorphic lens is attached. When the anamorphic lens is used, a shot image in which an object is compressed in a horizontal direction is obtained. By decompressing the shot image in the horizontal direction in post-production, an image showing a landscape angle of view as compared with a normal shot image is generated. In the shot image, the object is compressed in the horizontal direction, and blur is also compressed in the horizontal direction. FIG. 9 is a schematic diagram illustrating an example of a shape of blur occurring in a shot image obtained using an anamorphic lens. Circular blur becomes elliptical blur, and regular octagonal blur becomes vertically long octagonal blur.

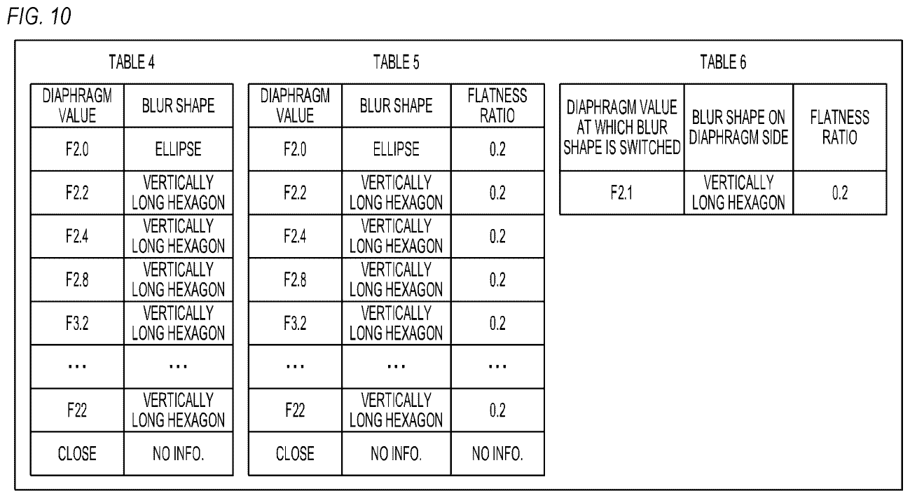

FIG. 10 is a schematic diagram illustrating an example of correspondence relationship information in which a special blur shape is considered. In FIG. 10, Tables 4 to 6 are illustrated as the correspondence relationship information. In Table 4, the blur shape-related information indicates the blur shape, and a plurality of combinations of the diaphragm value and the blur shape are described. An elliptical shape is illustrated as a blur shape during opening, and a vertically long hexagon is illustrated as blur shapes in other cases. In Table 5, the blur shape-related information indicates the blur shape and a flatness ratio (a degree of collapse of the blur shape compared to a perfect circle or a regular polygon), and a plurality of combinations of the diaphragm value, the blur shape, and the flatness ratio are described. The degree of collapse is not limited to the flatness ratio, and may be, for example, an eccentricity. Table 6 shows a threshold value that is a diaphragm value at which generated blur is switched between elliptical blur and vertically long polygonal blur, a shape of blur (vertically long polygon) that occurs when the diaphragm value is smaller than the threshold value (on the diaphragm side), and the flatness ratio common to elliptical blur and vertically long polygonal blur. By using Table 6, it can be determined that elliptical blur occurs when the diaphragm value is larger than the threshold value (on the opening side), and it can be determined that vertically long polygonal blur occurs when the diaphragm value is smaller than the threshold value (on the diaphragm side). Note that the threshold value may be a lower limit of a diaphragm value at which elliptical blur occurs or an upper limit of a diaphragm value at which vertically long polygonal blur occurs.

Although an example in which the correspondence relationship information is a table is described, the correspondence relationship information may be any type of information that can be used to generate (acquire) the blur shape-related information from the diaphragm value, and may be, for example, a function. Although an example in which the blur shape-related information indicates the blur shape is described, the blur shape-related information may be any type of information as long as the shape of blur can be determined from the diaphragm value, and may indicate, for example, a number of diaphragm blades, a shape of diaphragm blades, a type of diaphragm (circular diaphragm/polygonal diaphragm), and the like. To determine the blur shape from such type of information, the correspondence relationship information needs to be similarly stored as a table.

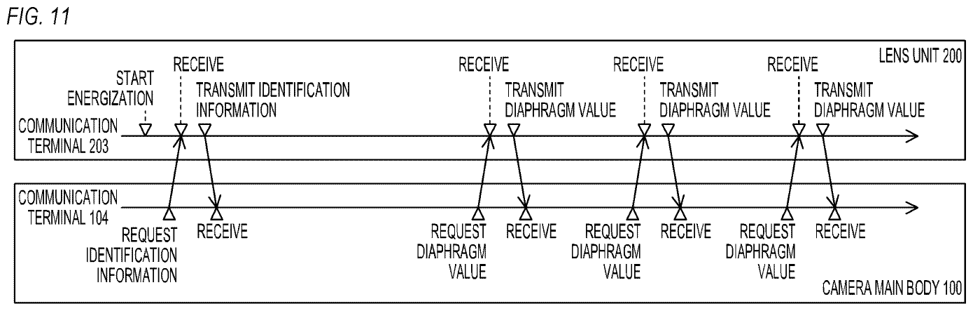

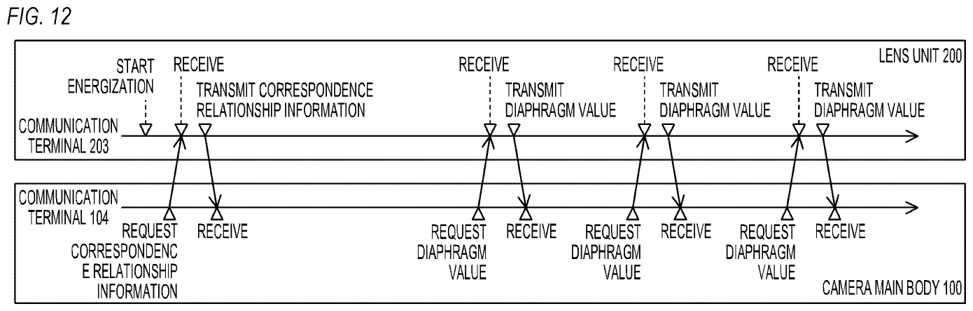

A timing for acquiring the blur shape-related information will be described with reference to FIGS. 11 and 12. FIGS. 11 and 12 are schematic diagrams illustrating communication between the camera main body 100 (communication terminal 104) and the lens unit 200 (communication terminal 203).

In the example of FIG. 11, a plurality of pieces of correspondence relationship information respectively corresponding to the plurality of lens units are stored in advance in the nonvolatile region of the memory 101. When the lens unit 200 is attached to the camera main body 100, the CPU 102 requests identification information of the lens unit 200 to the LPU 202. When the energization of the lens unit 200 is started, the LPU 202 reads identification information of the lens unit 200 from the nonvolatile region of the memory 201 in response to the request from the CPU 102, and transmits the read identification information to the CPU 102. The identification information of the lens unit 200 may be any type of information that can identify the lens unit 200, and is, for example, a name, a model number, a manufacturing number, and the like.

Although the identification information is transmitted from the lens unit 200 to the camera main body 100, the identification information may be generated in the camera main body 100. For example, a plurality of identification buttons that can be pressed by the lens unit may be provided in the camera main body 100, and a plurality of pieces of identification information respectively corresponding to the plurality of lens units may be stored in advance in the nonvolatile region of the memory 101. Then, the CPU 102 may acquire any of the plurality of pieces of identification information from the memory 101 according to a pressed state of the plurality of identification buttons.

A timing of acquiring the identification information is not limited to the above-described timing. For example, the identification information may be deleted from the memory 101 according to transition to a power saving state, and the identification information may be reacquired at a timing of returning from the power saving state.

When the identification information is acquired, the CPU 102 acquires the correspondence relationship information corresponding to the lens unit 200 from the memory 101 based on the identification information.

Thereafter, the CPU 102 requests the diaphragm value to the LPU 202, and the LPU 202 transmits the diaphragm value to the CPU 102 in response to the request. The CPU 102 acquires the blur shape-related information corresponding to the acquired diaphragm value based on the correspondence relationship information. Transmission and reception of the diaphragm value and acquisition of the blur shape-related information are repeatedly performed. The processes may be performed for each frame, or may be performed only when a change occurs in the diaphragm value.

In the example of FIG. 12, the correspondence relationship information of the lens unit 200 is stored in advance in the nonvolatile region of the memory 201. When the lens unit 200 is attached to the camera main body 100, the CPU 102 requests the correspondence relationship information of the lens unit 200 to the LPU 202. When energization of the lens unit 200 is started, the LPU 202 reads the correspondence relationship information of the lens unit 200 from the nonvolatile region of the memory 201 in response to the request from the CPU 102, and transmits the read correspondence relationship information to the CPU 102. The CPU 102 stores the acquired correspondence relationship information in the volatile region of the memory 101.

A timing of acquiring the correspondence relationship information is not limited to the above-described timing. For example, the correspondence relationship information may be deleted from the memory 101 according to transition to a power saving state, and the correspondence relationship information may be reacquired at a timing of returning from the power saving state.

When the correspondence relationship information is acquired, the CPU 102 requests the diaphragm value to the LPU 202, and the LPU 202 transmits the diaphragm value to the CPU 102 in response to the request. The CPU 102 acquires the blur shape-related information corresponding to the acquired diaphragm value based on the acquired correspondence relationship information (correspondence relationship information stored in the memory 101).

The CPU 102 outputs the diaphragm value and the blur shape-related information acquired by the above method. For example, the CPU 102 outputs the diaphragm value and the blur shape-related information to the outside from the output terminal 105 or records the diaphragm value and the blur shape-related information in the recording medium 106 in association with the shot image (frame). Here, the CPU 102 may record or output the diaphragm value and the blur shape-related information in a manufacturer-unique region of existing metadata or protocol, such as RDD-18 of EXIF or SMPTE. The CPU 102 may record or output the diaphragm value and the blur shape-related information using a manufacturer-unique standard (for example, a manufacturer-unique communication standard). The CPU 102 may record or output a diaphragm value defined by a resolution or a format suitable for giving blur separately from the diaphragm value stored in the existing metadata. For example, an F-number may be an F-number of 0.01 resolution obtained by multiplying the diaphragm value by 100, or an F-number in a log format of 16-bit resolution.

As described above, the output diaphragm value is used to determine the blur intensity of the graphic, and the output blur shape-related information is used to determine the blur shape of the graphic. However, an object to apply the output diaphragm value and the blur shape-related information varies depending on a method of VFX shooting. In the in-camera method, the diaphragm value and the blur shape-related information are applied to the graphic to be displayed on the display device that is one of the shooting targets, and in the post-production method, the diaphragm value and the blur shape-related information are applied to the graphic to be synthesized with the shot image.

The in-camera method will be described in more detail. The CPU 102 outputs the diaphragm value and the blur shape-related information to the CG generation device connected to the output terminal 105 in real time (by sequentially processing the input shot image). The CG generation device generates a graphic based on the diaphragm value and the blur shape-related information acquired from the camera main body 100 (CPU 102), and outputs the generated graphic to the display device. After the graphic without blur is generated, blur based on the diaphragm value and the blur shape-related information may be applied to the graphic, or a graphic with blur based on the diaphragm value and the blur shape-related information may be generated without generating the graphic without blur. The method of applying blur is not particularly limited, but for example, blur is applied by filter processing using a filter based on the diaphragm value and the blur shape-related information for each region. The display device displays the graphic generated by the CG generation device. Thereafter, the camera main body 100 performs shooting of an image at an angle of view including the graphic displayed on the display device and the real object, thereby obtaining a shot image that is a natural synthetic image (synthetic image without discomfort) in which blur of the real object and blur of the graphic match each other. Note that a device that generates graphic and a device that outputs graphic to a display device (a device that controls display on the display device) may be different. As the CG generation device, a CG generation system including a plurality of devices may be used.

The post-production method will be described in more detail. The CPU 102 records the shot image, the diaphragm value, and the blur shape-related information in the recording medium 106 in association with each other. The file of the shot image, the file of the diaphragm value, and the file of the blur shape-related information may be the same as or different from each other. The shot image, the diaphragm value, and the blur shape-related information may be recorded in different media. Thereafter, the recording medium 106 is taken out from the camera main body 100 and is input to the CG synthesis device, and the shot image, the diaphragm value, and the blur shape-related information are transferred to the CG synthesis device. The CG synthesis device generates a graphic based on the diaphragm value and the blur shape-related information. As in the in-camera method, after a graphic without blur is generated, blur based on the diaphragm value and the blur shape-related information may be applied to the graphic. A graphic with blur based on the diaphragm value and the blur shape-related information may be generated without generating a graphic without blur. The method of applying blur is not particularly limited, but for example, blur is applied by filter processing using a filter based on the diaphragm value and the blur shape-related information for each region. Then, the CG synthesis device synthesizes the generated graphic with the shot image. As a result, a natural synthetic image (synthetic image without discomfort) in which blur of the real object and blur of the graphic match each other can be obtained.

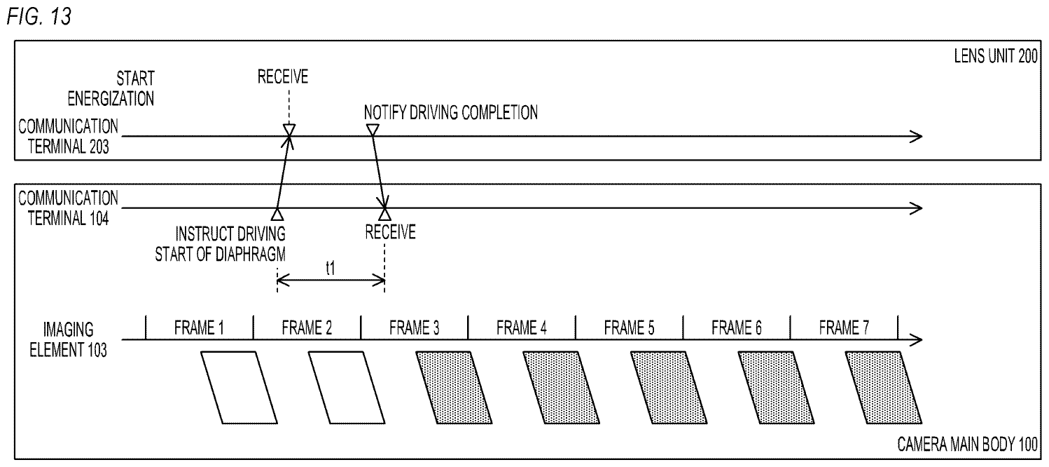

Finally, a timing of each processing in VFX shooting of the in-camera method will be described with reference to FIGS. 13 to 15.

FIG. 13 is a schematic diagram illustrating an example of a timing of communication between the camera main body 100 (communication terminal 104) and the lens unit 200 (communication terminal 203) and a timing at which the camera main body 100 (imaging element 103) performs shooting. The imaging element 103 performs shooting at a certain time interval according to a set frame rate.

In FIG. 13, driving of the diaphragm 204 occurs during a period of frame 2 by a change in brightness of an object or an operation from a user. Specifically, after starting the period of the frame 2, the CPU 102 instructs a driving start of the diaphragm 204 to the LPU 202. Then, the LPU 202 drives a motor that controls the diaphragm 204 according to an instruction from the CPU 102, and changes an aperture diameter of the diaphragm 204. When the driving of the diaphragm 204 is completed, the LPU 202 notifies the CPU 102 that the driving of the diaphragm 204 is completed. As a notification of completion of the driving of the diaphragm 204, notification of the changed diaphragm value or the like may be performed. Notification may be started before the driving of the diaphragm 204 is completed so that the notification is not delayed due to a communication time. For example, a timing at which the driving of the diaphragm 204 is completed may be predicted, and the notification may be started at a timing earlier by the communication time from the predicted timing. In FIG. 13, the CPU 102 receives the notification of completion of the driving of the diaphragm 204 during a period of frame 3. Therefore, a shot image corresponding to the changed diaphragm value is obtained as the shot image of the frame 3 and subsequent frames.

In FIG. 13, time t1 is required for the driving of the diaphragm 204. Note that the time t1 in FIG. 13 is an example, and a time required for the driving of the diaphragm 204 may be longer or shorter than the time t1. An upper limit of a driving speed of the diaphragm 204 may be determined considering noise during shooting, and the time required for the driving of the diaphragm 204 (change of the aperture diameter) may depend on a driving amount (change amount) of the diaphragm 204. The time t1 is a time from when the CPU 102 instructs the driving start of the diaphragm 204 until when the notification of the completion of the driving of the diaphragm 204 is received, but the time required for the driving of the diaphragm 204 may be a time until the completion of the driving of the diaphragm 204 or a time from the start of the driving of the diaphragm 204.

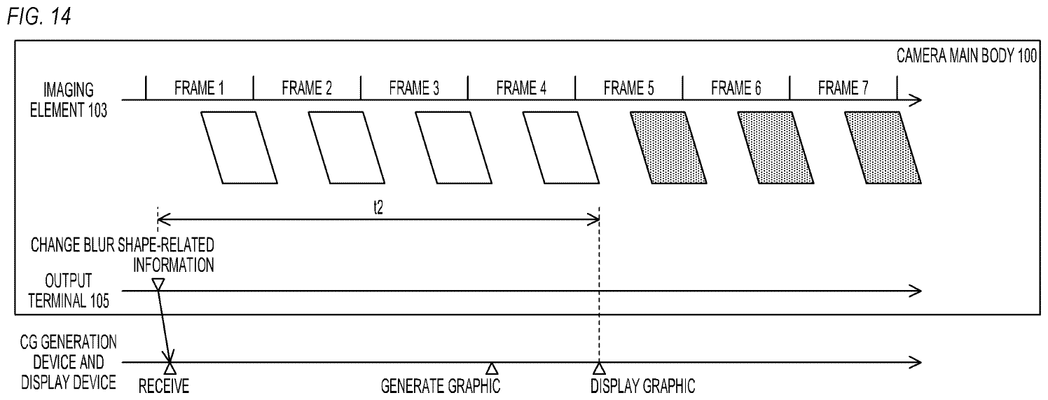

FIG. 14 is a schematic diagram illustrating an example of a timing of communication between the camera main body 100 (output terminal 105) and the CG generation device. Transmission and reception of the shot image and the diaphragm value are omitted. In FIG. 14, the blur shape-related information is changed in a period of frame 1. The CPU 102 notifies the CG generation device of the changed blur shape-related information, and the CG generation device generates (updates) the graphic based on the changed blur shape-related information. Then, the CG generation device outputs the generated graphic to the display device, and the display device displays the graphic. In FIG. 14, display of the graphic based on the changed blur shape-related information is started during a period of frame 5. Therefore, the shot image including the graphic corresponding to the changed blur shape-related information is obtained as the shot image of the frame 5 and subsequent frames.

In FIG. 14, time t2 is required from when the CPU 102 outputs the blur shape-related information until when the display device starts display of the graphic after applying the blur shape-related information.

Generally, the time t1 and the time t2 are different. Although the time depends on machine power of the CG generation device, generally, a relatively long time is required for generating a graphic, and the time t2 is longer than the time t1. Therefore, when the CPU 102 outputs diaphragm driving start instruction and the blur shape-related information at the same timing, a timing at which the changed diaphragm value is applied to the shot image (real object) does not match a timing at which the changed blur shape-related information is applied to the graphic. Then, in a period during which only one of the changed diaphragm value and the changed blur shape-related information is applied, an unnatural synthetic image (synthetic image with discomfort) in which the blur shape of the graphic and the blur shape of the real object do not match each other is obtained as the shot image.

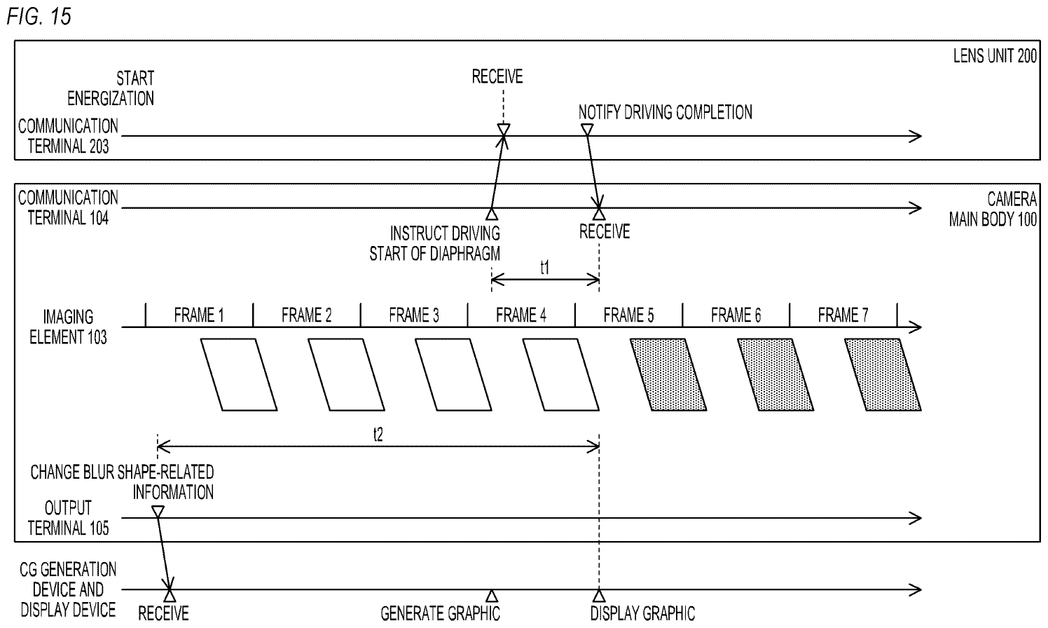

Therefore, in the first embodiment, the CPU 102 controls at least one of a timing of instructing the driving start of the diaphragm 204 and a timing of outputting the blur shape-related information based on the times t1 and t2. FIG. 15 illustrates an example of various timings controlled based on the times t1 and t2. In FIG. 15, since the time t2 is longer than the time t1, the CPU 102 instructs the driving start of the diaphragm 204 after outputting the blur shape-related information. More specifically, the CPU 102 instructs the driving start of the diaphragm 204 at a timing when (t2−t1) time is elapsed after outputting the blur shape-related information. The CPU 102 knows the changed diaphragm value in advance when instructing the driving start of the diaphragm 204, and outputs the blur shape-related information corresponding to the changed diaphragm value. Then, the CPU 102 issues an instruction to drive the diaphragm 204 by a driving amount based on the changed diaphragm value as the instruction of the driving start of the diaphragm 204. As such, the timing at which the changed diaphragm value is applied to the shot image (real object) and the timing at which the changed blur shape-related information is applied to the graphic can be brought close to (match) each other. As a result, it is possible to shorten (eliminate) a period during which an unnatural shot image (unnatural synthetic image) is acquired.

The CPU 102 may control a timing at which the camera main body 100 (imaging element 103) performs shooting of each frame based on the times t1 and t2 so that the diaphragm value and the blur shape-related information are not changed midway of the frame. Based on the times t1 and t2, the CPU 102 controls at least one of the timing of outputting the blur shape-related information, the timing of instructing the driving start of the diaphragm 204, and the timing of performing shooting. Information of the times t1 and t2 may or may not be acquired by communication. The user may measure the times t1 and t2 and input the times t1 and t2 to the camera main body 100.

### Second Embodiment

Hereinafter, a second embodiment of the present invention will be described. In the first embodiment, the present invention is applied to an imaging apparatus in which a lens unit is interchangeable (interchangeable lens camera). In the second embodiment, the present invention is applied to an imaging apparatus in which a lens unit is not interchangeable (lens-integrated camera). Note that descriptions of parts common to the first embodiment will be omitted.

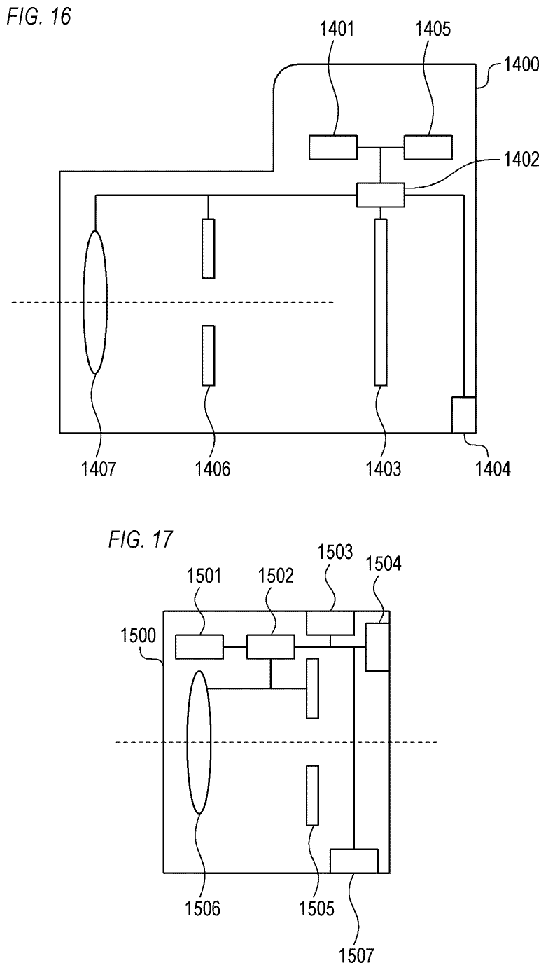

FIG. 16 is a block diagram illustrating a configuration of a camera 1400 according to the second embodiment. The camera 1400 includes a memory 1401, a CPU 1402, an imaging element 1403, an output terminal 1404, a recording medium 1405, a diaphragm 1406, and a lens group 1407. The memory 1401, the CPU 1402, the imaging element 1403, the output terminal 1404, and the recording medium 1405 have functions similar to the functions of the memory 101, the CPU 102, the imaging element 103, the output terminal 105, and the recording medium 106 in FIG. 1. The diaphragm 1406 and the lens group 1407 have functions similar to the functions of the diaphragm 204 and the lens group 205. The memory 1401 further has functions similar to at least a part of the function of the memory 201, and the CPU 1402 further has functions similar to at least a part of the function of the LPU 202.

Since the camera 1400 has a configuration in which the lens unit and the camera main body are integrated, the diaphragm 1406 and the lens group 1407 are directly connected to the CPU 1402, and the CPU 1402 directly transmits a control signal to the diaphragm 1406 and the lens group 1407. Therefore, the CPU 1402 can know a diaphragm value of the diaphragm 1406 in real time. Correspondence relationship information indicating a correspondence relationship between the diaphragm value and the blur shape-related information is stored in a nonvolatile region of the memory 1401, and the CPU 1402 can acquire the blur shape-related information corresponding to the diaphragm value to be output from the memory 1401. The CPU 1402 may acquire the blur shape-related information from the nonvolatile region of the memory 1401, or may load the correspondence relationship information from the nonvolatile region of the memory 1401 to a volatile region and acquire the blur shape-related information from the volatile region.

### Third Embodiment

Hereinafter, a third embodiment of the present invention will be described. In the third embodiment, the present invention is applied to a lens unit detachable from an imaging apparatus. Note that descriptions of parts common to the first embodiment will be omitted.

FIG. 17 is a block diagram illustrating a configuration of a lens unit 1500 according to the third embodiment. The lens unit 1500 includes a memory 1501, an LPU 1502, an operation member 1503, a communication terminal 1504, a diaphragm 1505, a lens group 1506, and an output terminal 1507. The memory 1501, the LPU 1502, the communication terminal 1504, the diaphragm 1505, the lens group 1506, and the output terminal 1507 have functions similar to the functions of the memory 201, the LPU 202, the communication terminal 203, the diaphragm 204, the lens group 205, and the output terminal 105 in FIG. 1. The memory 1501 further has functions similar to at least a part of the function of the memory 101, and the LPU 1502 further has functions similar to at least a part of the function of the CPU 102.

The operation member 1503 is an operation member capable of receiving an operation of changing an aperture diameter (diaphragm value) of the diaphragm 1505, and is, for example, a diaphragm ring or a touch panel. The LPU 1502 drives the diaphragm 1505 according to the operation on the operation member 1503 and acquires the changed diaphragm value. The LPU 1502 may be instructed to drive the diaphragm 1505 from the camera main body to which the lens unit 1500 is attached via the communication terminal 1504. Also here, the LPU 1502 drives the diaphragm 1505 according to the instruction from the camera main body and acquires the changed diaphragm value. The LPU 1502 may acquire a shot image from the camera main body to which the lens unit 1500 is attached via the communication terminal 1504.

Correspondence relationship information indicating a correspondence relationship between the diaphragm value and the blur shape-related information is stored in a nonvolatile region of the memory 1501, and the LPU 1502 can acquire the blur shape-related information corresponding to the diaphragm value to be output from the memory 1501. The LPU 1502 may acquire the blur shape-related information from the nonvolatile region of the memory 1501, or may load the correspondence relationship information from the nonvolatile region of the memory 1501 to a volatile region and may acquire the blur shape-related information from the volatile region. The LPU 1502 outputs the acquired shot image, the acquired diaphragm value, the acquired blur shape-related information, and the like to the outside from the output terminal 1507 or the communication terminal 1504.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present invention are also included in the present invention. The present invention also includes other configurations obtained by suitably combining various features of the embodiment.

In the above-described embodiments, the present invention is applied to a camera or a lens unit, but the present invention may be applied to any electronic apparatus (information processing apparatus) that can output information useful for VFX shooting.

According to the present invention, it is possible to obtain a more natural image (image with less discomfort) as a synthetic image obtained by synthesizing a real object with a graphic.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to embodiments, it is to be understood that the invention is not limited to the disclosed embodiments but is defined by the scope of the following claims.

This application claims the benefit of Japanese Patent Application No. 2024-055498, filed on Mar. 29, 2024, which is hereby incorporated by reference herein in its entirety.

What is claimed is:

1. An information processing apparatus comprising:
a processor; and
a memory storing a program which, when executed by the processor, causes the information processing apparatus to
execute acquisition processing of acquiring a diaphragm value of a lens of an imaging apparatus, and
execute output processing of outputting the diaphragm value acquired during capturing of a captured image of the imaging apparatus and blur shape-related information related to a shape of blur occurring in the captured image.

2. The information processing apparatus according to claim 1, wherein
in the acquisition processing, the diaphragm value is acquired in real time during capturing of the captured image, and
in the output processing, the diaphragm value and the blur shape-related information are outputted in real time during capturing of the captured image.

3. The information processing apparatus according to claim 1, wherein in the output processing, the captured image of the imaging apparatus is further outputted.

4. The information processing apparatus according to claim 1, further comprising:
a storage having correspondence relationship information stored thereon indicating a correspondence relationship between a diaphragm value and blur shape-related information, wherein
in the output processing, blur shape-related information corresponding to the diaphragm value to be output is acquired based on the correspondence relationship information and the blur shape-related information is outputted.

5. The information processing apparatus according to claim 4, wherein
the storage has stored thereon a plurality of pieces of correspondence relationship information respectively corresponding to a plurality of lenses,
the program, when executed by the processor, further causes the information processing apparatus to execute second acquisition processing of acquiring identification information of the lens of the imaging apparatus, and
in the output processing, the blur shape-related information corresponding to the diaphragm value to be output is acquired based on the correspondence relationship information corresponding to the lens of the imaging apparatus and the blur shape-related information is outputted.

6. The information processing apparatus according to claim 4, further comprising:
the program, when executed by the processor, further causes the information processing apparatus to execute third acquisition processing of acquiring the correspondence relationship information from outside.

7. The information processing apparatus according to claim 1, wherein
the blur shape-related information indicates the shape of blur.

8. The information processing apparatus according to claim 7, wherein
the blur shape-related information further indicates similarity of the shape of blur compared to a perfect circle.

9. The information processing apparatus according to claim 7, wherein
the blur shape-related information further indicates a degree of collapse of the shape of blur compared to a perfect circle or a regular polygon.

10. The information processing apparatus according to claim 1, wherein
in the output processing, the diaphragm value and the blur shape-related information are outputted to outside.

11. The information processing apparatus according to claim 1, wherein
in the output processing, the diaphragm value and the blur shape-related information are recorded in a recording medium provided in the information processing apparatus.

12. The information processing apparatus according to claim 1, wherein
the blur shape-related information is applied to a graphic to be synthesized with the captured image.

13. The information processing apparatus according to claim 1, wherein
the blur shape-related information is applied to a graphic displayed on a display device to be captured by the imaging apparatus.

14. The information processing apparatus according to claim 13, wherein
the program, when executed by the processor, further causes the information processing apparatus to
execute instruction processing of instructing driving start of a diaphragm, and
execute control processing, and
in the control processing, at least one of a timing at which the blur shape-related information is outputted in the output processing, a timing at which the driving start of the diaphragm is instructed in the instruction processing, and a timing at which the imaging apparatus performs capturing is controlled based on
a first time that is a time required for driving of the diaphragm of the lens and
a second time that is a time from when the blur shape-related information is outputted in the output processing until when the display device starts displaying the graphic after the blur shape-related information is applied.

15. The information processing apparatus according to claim 14, wherein
in the control processing, at least one of the timing at which the blur shape-related information is outputted in the output processing and the timing at which the driving start of the diaphragm is instructed in the instruction processing is controlled so that the driving start of the diaphragm is instructed in the instruction processing after the blur shape-related information is outputted in the output processing.

16. The information processing apparatus according to claim 1, wherein
the information processing apparatus is the imaging apparatus of which the lens is interchangeable.

17. The information processing apparatus according to claim 1, wherein
the information processing apparatus is the imaging apparatus of which the lens is not interchangeable.

18. The information processing apparatus according to claim 1, wherein
the information processing apparatus is the lens detachable from the imaging apparatus.

19. The information processing apparatus according to claim 1, wherein
in the output processing, metadata storing the diaphragm value and the blur shape-related information is outputted in a manufacturer-unique region.

20. The information processing apparatus according to claim 1, wherein
in the output processing, the diaphragm value and the blur shape-related information are outputted using a manufacturer-unique standard.

21. The information processing apparatus according to claim 1, wherein
the diaphragm value is a value in a log format of 16-bit resolution.

22. An information processing method comprising:
acquiring a diaphragm value of a lens of an imaging apparatus; and
outputting the diaphragm value acquired during capturing of a captured image of the imaging apparatus and blur shape-related information related to a shape of blur occurring in the captured image.

23. The information processing method according to claim 22, wherein the diaphragm value is acquired in real time during capturing of the captured image and the outputting of the diaphragm value and blur shape-related information is carried out in real time during capturing of the captured image.

24. A non-transitory computer readable medium that stores a program, wherein the program causes a computer to execute an information processing method comprising:
acquiring a diaphragm value of a lens of an imaging apparatus; and
outputting the diaphragm value acquired during capturing of a captured image of the imaging apparatus and blur shape-related information related to a shape of blur occurring in the captured image.
